(19) United States
(12) Patent Application Publication
(10) Pub. No.: US 2021/0141982 A1
(43) Pub. Date: May 13, 2021

(54) SYSTEM AND METHOD FOR PIPING SUPPORT DESIGN

(71) Applicant: SIEMENS AKTIENGESELLSCHAFT, Munich (DE)

(72) Inventors: Naresh AHUJA, Gurgaon (IN); Karthik ARAVAMUDHAN, Ghaziabad (IN)

(21) Appl. No.: 17/041,990

(22) PCT Filed: Mar. 28, 2019
(86) PCT No.: PCT/EP2019/057836

§ 371 Date: Sep. 25, 2020

(30) Foreign Application Priority Data
Mar. 28, 2018 (EP) 18164568.0

(51) Int. Cl. G06F 30/23

(52) U.S. Cl. CPC G06F 30/23; G06F 2113/14

(57) ABSTRACT

A piping stress analysis system is provided. The piping stress analysis system obtains piping data associated with one or more pipes, generates piping stresses based on the piping data using mathematical models, obtains mathematical coefficients based on the piping stresses, and generates an updated set of piping stresses using the mathematical coefficients. The updated set of piping stresses are used for designing a support structure for the pipes in a time and cost effective manner.

This application is the National Stage of International Application No. PCT/EP2019/057836, filed Mar. 28, 2019, which claims the benefit of European Patent Application No. EP 18164568.0, filed Mar. 28, 2018. The entire contents of these documents are hereby incorporated herein by reference.

### BACKGROUND

The present embodiments relate to designing support structures for piping based on estimation of induced stresses.

Support structures, typically used in power plants for piping arrangements include dynamic clamps. FIG. 1 illustrates a perspective view of a support structure 100 of the state of the art, supporting a pipe 101. As shown in FIG. 1, the support structure 100 of the state of the art includes a standard dynamic clamp 102 being held in position around the pipe 101, by a pair of propping members 103 and 104, known as struts. Such a support structure 100 is known to induce low amount of stresses at a pipe-trunnion interface 105. However, designing and manufacturing of such support structures 100 is costly, time consuming, and labor intensive. Alternatively, welded attachment geometries for support structures are also known to a person skilled in the art. However, such welded geometries induce high amount of stresses in pipe attachment interfaces, which are required to be accurately estimated and considered while designing the support structures.

Conventional methods and systems known to a person skilled in the art for estimating induced stresses in support structures for piping include rigorous finite element analysis methods. The finite element analysis methods, although accurate, are required to be executed on a case to case basis, thereby resulting in a costly and time consuming process of estimating induced stresses and designing the support structures. Alternatively, methods such as WRC-297 (Welding research council bulletin no.-297) are used for estimating induced stresses in mechanical components. However, such methods fail to provide accuracy of estimation at higher induced stress levels, thereby resulting in an inaccurate estimation leading to faulty designs of the support structures.

### SUMMARY AND DESCRIPTION

The scope of the present invention is defined solely by the appended claims and is not affected to any degree by the statements within this summary.

The present embodiments may obviate one or more of the drawbacks or limitations in the related art. For example, a piping stress analysis system and a method that accurately estimate induced stresses required for designing a reliable piping support structure without increase in costs and time consumed are provided.

The piping stress analysis system and method disclosed in the present embodiments obtain mathematical coefficients based on piping stresses estimated using conventional statistical models and update these piping stresses based on the mathematical coefficients. The updated piping stresses are used for designing a support structure for one or more pipes.

According to the present embodiments, a piping stress analysis system is provided. The piping stress analysis system, in one aspect of the present embodiments, is installed on and accessible by a user device (e.g., a personal computing device, a workstation, a client device, a network enabled computing device, any other suitable computing equipment, and combinations of multiple pieces of computing equipment). In another aspect of the present embodiments, the piping stress analysis system is downloadable and usable on the user device, and is configured as a web based platform (e.g., a website hosted on a server or a network of servers) and/or is implemented in the cloud computing environment. In yet another aspect of the present embodiments, the piping stress analysis system includes a non-transitory computer readable storage medium and at least one processor communicatively coupled to the non-transitory computer readable storage medium. As used herein, “non-transitory computer readable storage medium” refers to all computer readable media (e.g., non-volatile media, volatile media, and transmission media except for a transitory, propagating signal). The non-transitory computer readable storage medium is configured to store computer program instructions defined by modules of the piping stress analysis system including, for example, a data reception module, a first mathematical model, a second mathematical model, and a stress optimization statistical model. The processor is configured to execute the defined computer program instructions.

The data reception module obtains piping data associated with one or more pipes. According to an embodiment, the piping data is associated with one or more pipes of a power plant. In one aspect of the present embodiments, “piping data” refers to physical data associated with the pipes to be supported by the support structure. In this aspect of the present embodiments, the physical data includes an outer diameter, a wall thickness, a length, and a material of each of the pipes. In another aspect of the present embodiments, “piping data” refers to physical data associated with the support structure. In this aspect of the present embodiments, the physical data includes an outer diameter, a wall thickness, a length, and a material of the support structure. In this aspect of the present embodiments, the support structure is configured as a trunnion pipe. In yet another aspect of the present embodiments, “piping data” refers to external factors affecting the support structure and the pipes. In this aspect of the present embodiments, the external factors include a mechanical load exerted on the support structure, a mechanical load exerted on the pipes, an internal pressure of the pipes, and an internal temperature of the pipes. According to an embodiment of the present embodiments, the data reception module obtains the piping data from one or more external sources including repositories storing piping and instrumentation diagrams, piping material databases, piping datasheets, piping standards, piping codes, etc. According to an embodiment, the piping stress analysis system includes a piping database for storing the piping data obtained.

The first mathematical model generates a first set of piping stresses based on the piping data. The first mathematical model is a physics based numerical model (e.g., a finite element analysis model). The first mathematical model processes piping data including a plurality of combinations of, for example, piping geometries, piping materials, loading, etc. The first mathematical model generates the first set of piping stresses including a membrane stress and/or a bending stress experienced by the support structure that is to be designed for supporting each of the combinations processed. The membrane stresses are a stress component of the general stresses experienced by pipes (e.g., pressure vessels commonly having the form of spheres, cylinders, cones, ellipsoids, or composites of such shapes). When a thickness of such a vessel is small in comparison with other dimensions of the pressure vessel, the vessel is referred to as a membrane, and the associated stress resulting from a pressure contained within the vessel is referred to as membrane stress. These membrane stresses are average tension or compression stresses and are assumed to be uniform across the vessel wall, acting tangential to surface. The membrane or wall is assumed to offer no resistance to bending. When the wall offers resistance to bending, bending stresses occur in addition to membrane stresses.

The second mathematical model generates a second set of piping stresses based on the piping data. The second mathematical model is an empirical model such as, for example, WRC 297 (Welding Research Council bulletin no. 297), which is a parameterized procedure for stress calculation especially around a junction of a support structure and a pipe that the support structure supports. According to an embodiment, the piping data that the second mathematical model processes is the same as the piping data that the first mathematical model has processed. In other words, the piping data includes a plurality of combinations of, for example, piping geometries, piping materials, loading, etc. The second mathematical model generates the second set of piping stresses including a membrane stress and/or a bending stress experienced by the support structure to be designed for supporting each of the combinations processed.

The stress optimization statistical model includes a coefficient generation module and a stress computation module. The stress optimization statistical model is a regression model. The coefficient generation module obtains mathematical coefficients based on the first set of piping stresses and the second set of piping stresses. The mathematical coefficients include at least one mathematical constant. The coefficient generation module includes a relationship plotting module and a relationship identification module. The relationship plotting module generates at least one relationship plot of the first set of piping stresses and the second set of piping stresses. As used herein, “relationship plot” refers to a plurality of data points each representing a membrane stress and/or a bending stress. In one aspect of the present embodiments, relationship plot includes a plot of membrane stresses that each of the first mathematical model and the second mathematical model generate. In another aspect of the present embodiments, the relationship plot includes a plot of membrane stresses and bending stresses in combination that each of the first mathematical model and the second mathematical model generate. The relationship identification module identifies a data pattern in each relationship plot, associated with the first set of piping stresses and the second set of piping stresses. The relationship identification module identifies the data pattern by determining at least one data point on each relationship plot such that, a line drawn through this data point accommodates below the line a majority of other data points on the relationship plot. The mathematical coefficients are obtained from a slope and a ‘Y’ intercept of this data pattern (e.g., the line). According to an embodiment, the piping stress analysis system includes a coefficient database storing the mathematical coefficients along with the first set of piping stresses and the second set of piping stresses.

The stress computation module generates an updated set of piping stresses using the mathematical coefficients. The updated set of piping stresses are used for designing a support structure for the one or more pipes. In one embodiment, the stress computation module updates the second set of piping stresses generated by the second mathematical model, using the mathematical coefficients. The piping stress analysis system optimizes stresses using the mathematical coefficients in order to decrease anomalies in design of the support structure that arise due to a variance in the inputs provided to mathematical models and to provide reliability and safety of the support structure design.

Also disclosed herein is a method for determining piping stresses for a pipe by using the piping stress analysis system described above. According to the method disclosed herein, the data reception module obtains design data associated with the pipe. As used herein, “design data” refers to piping data associated with a single pipe. In other words, instead of a plurality of pipe geometries, pipe materials, and pipe loading parameters, the design data includes data associated with geometry, material, and loading of a single pipe to be supported by the support structure being designed. The design data also includes data associated with the support structure intended to be used. The second mathematical model generates initial piping stresses including membrane stresses and/or bending stresses, based on the design data. The coefficient generation module obtains the mathematical coefficients from the coefficient database based on the initial piping stresses. The stress computation module generates updated piping stresses using the initial piping stresses and the mathematical coefficients. A support structure is then designed for the pipe based on the updated piping stresses. According to an embodiment, the method includes validating the updated piping stresses based on a predefined stress range defined based on standards (e.g., ASME/EP piping codes, etc.). According to this embodiment, when the updated piping stresses are not valid with respect to the predefined stress range, the method includes modifying the design data, for example, by modifying geometry of the support structure, and reiterating the acts of generating initial piping stresses, obtaining mathematical coefficients, generating updated piping stresses, and validating updated piping stresses until the updated piping stresses are valid with respect to the predefined stress range.

Also disclosed herein is a method for analyzing piping stresses for one or more pipes. According to the method disclosed herein, piping data associated with the one or more pipes is obtained. At least a first set of piping stresses is generated by a first mathematical model based on the piping data, at least a second set of piping stresses is generated by a second mathematical model based on the piping data, and mathematical coefficients are obtained based on the first set of piping stresses and the second set of piping stresses by generating at least one relationship plot and identifying a data pattern in the at least one relationship plot. An updated set of piping stresses are generated using the mathematical coefficients. According to the method disclosed herein, the updated set of piping stresses are used for designing a support structure for one or more pipes.

Also disclosed herein is a computer program product including a non-transitory computer readable storage medium storing computer program codes that include instructions executable by at least one processor for performing the method acts disclosed above for analyzing piping stresses for one or more pipes and the method acts disclosed above for designing a support structure for one or more pipes by employing the piping stress analysis system.

The illustrated embodiments, discussed below, are intended to illustrate, but not limit the invention.

### BRIEF DESCRIPTION OF THE DRAWINGS

FIG. 1 illustrates a perspective view of a support structure of the state of the art, supporting a pipe.

FIG. 2 illustrates one embodiment of a piping stress analysis system for analyzing piping stresses for one or more pipes.

FIG. 3 is a block diagram illustrating exemplary architecture of a computer system employed by the piping stress analysis system illustrated in FIG. 2.

FIG. 4 is a process flowchart illustrating one embodiment of a method for analyzing piping stresses for one or more pipes employing the piping stress analysis system illustrated in FIG. 2.

FIG. 5 is a process flowchart illustrating one embodiment of a method for designing a support structure for one or more pipes by using the piping stress analysis system illustrated in FIG. 2.

FIGS. 6A-6B illustrate exemplary relationship plots between one or more sets of piping stresses generated by the piping stress analysis system.

FIG. 7 illustrates a perspective view of an embodiment of a support structure for which the stresses have been determined by employing the piping stress analysis system illustrated in FIG. 2 and the process flow chart illustrated in FIG. 5.

### DETAILED DESCRIPTION

Various embodiments are described with reference to the drawings, where like reference numerals are used to refer to like elements throughout. In the following description, for the purpose of explanation, numerous specific details are set forth in order to provide thorough understanding of one or more embodiments. It may be evident that such embodiments may be practiced without these specific details.

FIG. 2 illustrates one embodiment of a piping stress analysis system 200 for analyzing piping stresses for one or more pipes. The piping stress analysis system 200 includes a data reception module 201, a first mathematical model 202, a second mathematical model 203, and a stress optimization statistical model 204. The stress optimization statistical model 204 includes a coefficient generation module 205 and a stress computation module 206. The coefficient generation module 205 includes a relationship plotting module 205A and a relationship identification module 205B. The piping stress analysis system 200 also includes databases (e.g., a coefficient database 207 and a piping database 208). The databases 207 and/or 208 may reside either internal to or external to the piping stress analysis system 200, as shown in FIG. 2. The piping stress analysis system 200 is in communication with the databases 207 and/or 208 via a communication network 209. The communication network 209 includes, for example, a wired network, a wireless network, or a cloud based network. The communication network 209 may also represent a network shared for Internet of Things (IoT).

FIG. 3 is a block diagram illustrating architecture of one embodiment of a computer system 300 employed by the piping stress analysis system 200 illustrated in FIG. 2. The piping stress analysis system 200 employs the architecture of the computer system 300 illustrated in FIG. 3. The computer system 300 is programmable using a high level computer programming language. The computer system 300 may be implemented using programmed and purposeful hardware. As illustrated in FIG. 3, the computer system 300 includes a processor 301, a non-transitory computer readable storage medium such as a memory unit 302 for storing programs and data, an input/output (I/O) controller 303, a network interface 304, a data bus 305, a display unit 306, input devices 307, a fixed media drive 308 such as a hard drive, a removable media drive 309 for receiving removable media, output devices 310, etc. The processor 301 refers to any one of microprocessors, central processing unit (CPU) devices, finite state machines, microcontrollers, digital signal processors, an application specific integrated circuit (ASIC), a field-programmable gate array (FPGA), etc., or any combination thereof, capable of executing computer programs or a series of commands, instructions, or state transitions. The processor 301 may also be implemented as a processor set including, for example, a general purpose microprocessor and a math or graphics co-processor. The processor 301 is selected, for example, from the Intel® processors, Advanced Micro Devices (AMD®) processors, International Business Machines (IBM®) processors, etc. The piping stress analysis system 200 disclosed herein is not limited to a computer system 300 employing a processor 301. The computer system 300 may also employ a controller or a microcontroller. The processor 301 executes the modules, for example, 201, 202, 203, 204, 205, 205A, 205B, 206, etc., of the piping stress analysis system 200.

The memory unit 302 is used for storing programs, applications, and data. For example, the data reception module 201, the first mathematical model 202, the second mathematical model 203, the stress optimization statistical model 204, the coefficient generation module 205, relationship plotting module 205A, the relationship identification module 205B, the stress computation module 206, etc., of the piping stress analysis system 200 are stored in the memory unit 302 of the computer system 300. The memory unit 302 is, for example, a random access memory (RAM) or another type of dynamic storage device that stores information and instructions for execution by the processor 301. The memory unit 302 also stores temporary variables and other intermediate information used during execution of the instructions by the processor 301. The computer system 300 further includes a read only memory (ROM) or another type of static storage device that stores static information and instructions for the processor 301. The I/O controller 303 controls input actions and output actions performed by the piping stress analysis system 200.

The network interface 304 enables connection of the computer system 300 to the communication network 209. For example, the piping stress analysis system 200 connects to the communication network 209 via the network interface 304. In an embodiment, the network interface 304 is provided as an interface card (e.g., a line card). The network interface 304 includes, for example, interfaces using serial protocols, interfaces using parallel protocols, and Ethernet communication interfaces, interfaces based on wireless communications technology such as satellite technology, radio frequency (RF) technology, near field communication, etc. The data bus 305 permits communications between the modules, for example, 201, 202, 203, 204, 205, 205A, 205B, 206, 207, 208, etc., of piping stress analysis system 200.

The display unit 306, via a graphical user interface (GUI) (not shown), displays information such as relationship plots, etc., for allowing a user to provide inputs of the user. The display unit 306 includes, for example, a liquid crystal display, a plasma display, an organic light emitting diode (OLED) based display, etc. The input devices 307 are used for inputting data into the computer system 300. The input devices 307 are, for example, a keyboard such as an alphanumeric keyboard, a touch sensitive display device, and/or any device capable of sensing a tactile input.

Computer applications and programs are used for operating the computer system 300. The programs are loaded into the fixed media drive 308 and into the memory unit 302 of the computer system 300 via the removable media drive 309. In an embodiment, the computer applications and programs may be loaded directly via the communication network 209. Computer applications and programs are executed by double clicking a related icon displayed on the display unit 306 using one of the input devices 307. The output devices 310 output the results of operations performed by the piping stress analysis system 200.

The processor 301 executes an operating system (e.g., the Linux® operating system, the Unix® operating system, any version of the Microsoft® Windows® operating system, the Mac OS of Apple Inc., the IBM® OS/2, etc.). The computer system 300 employs the operating system for performing multiple tasks. The operating system is responsible for management and coordination of activities and sharing of resources of the computer system 300. The operating system further manages security of the computer system 300, peripheral devices connected to the computer system 300, and network connections. The operating system employed on the computer system 300 recognizes, for example, inputs provided by the users using one of the input devices 307, the output display, files, and directories stored locally on the fixed media drive 308. The operating system on the computer system 300 executes different programs using the processor 301. The processor 301 and the operating system together define a computer platform for which application programs in high level programming languages are written.

The processor 301 of the computer system 300 employed by the piping stress analysis system 200 retrieves instructions defined by the modules, for example, 201, 202, 203, 204, 205, 205A, 205B, 206, etc., of the piping stress analysis system 200 for performing respective functions disclosed above. The processor 301 retrieves instructions for executing the modules, for example, 201, 202, 203, 204, 205, 205A, 205B, 206, etc., of the piping stress analysis system 200 from the memory unit 302. A program counter determines the location of the instructions in the memory unit 302. The program counter stores a number that identifies the current position in the program of each of the modules, for example, 201, 202, 203, 204, 205, 205A, 205B, 206, etc., of the piping stress analysis system 200. The instructions fetched by the processor 301 from the memory unit 302 after being processed are decoded. The instructions are stored in an instruction register in the processor 301. After processing and decoding, the processor 301 executes the instructions, thereby performing one or more processes defined by those instructions.

At the time of execution, the instructions stored in the instruction register are examined to determine the operations to be performed. The processor 301 then performs the specified operations. The operations include arithmetic operations and logic operations. The operating system performs multiple routines for performing a number of tasks required to assign the input devices 307, the output devices 310, and memory for execution of the modules, for example, 201, 202, 203, 204, 205, 205A, 205B, 206, etc., of the piping stress analysis system 200. The tasks performed by the operating system include, for example, assigning memory to the modules, for example, 201, 202, 203, 204, 205, 205A, 205B, 206, etc., of the piping stress analysis system 200, and to data used by the piping stress analysis system 200, moving data between the memory unit 302 and disk units, and handling input/output operations. The operating system performs the tasks on request by the operations, and after performing the tasks, the operating system transfers the execution control back to the processor 301. The processor 301 continues the execution to obtain one or more outputs. The outputs of the execution of the modules, for example, 201, 202, 203, 204, 205, 205A, 205B, 206, etc., of the piping stress analysis system 200 are displayed to the user on the GUI.

For purposes of illustration, the detailed description refers to the piping stress analysis system 200 being run locally on the computer system 300; however, the scope of the present embodiments is not limited to the piping stress analysis system 200 being run locally on the computer system 300 via the operating system and the processor 301, but may be extended to run remotely over the communication network 209 by employing a web browser and a remote server, or other electronic devices. One or more portions of the computer system 300 may be distributed across one or more computer systems (not shown) coupled to the communication network 209.

Disclosed herein is also a computer program product including a non-transitory computer readable storage medium that stores computer program codes including instructions executable by at least one processor 301 for performing method acts using the piping stress analysis system 200, as disclosed in the detailed description of FIG. 4 and FIG. 5. In an embodiment, a single piece of computer program code including computer executable instructions performs one or more acts of the method according to the present embodiments. The computer program codes including computer executable instructions are embodied on the non-transitory computer readable storage medium. The processor 301 of the computer system 300 retrieves these computer executable instructions and executes these computer executable instructions. When the computer executable instructions are executed by the processor 301, the computer executable instructions cause the processor 301 to perform the acts of the method for analyzing piping stresses for one or more pipes employing the piping stress analysis system 200 and the method for designing a support structure for one or more pipes by using the piping stress analysis system 200.

FIG. 4 is a process flowchart illustrating one embodiment of a method 400 for analyzing piping stresses for one or more pipes employing the piping stress analysis system 200 illustrated in FIG. 2. At act 401, the data reception module 201 of the piping stress analysis system 200 obtains piping data associated with the pipes. The data reception module 201 obtains piping data for a plurality of pipes and support structures (e.g., trunnion pipes supporting these pipes). The piping data includes, for example, about fifty cases each having a different pipe geometry, pipe material, and pipe loading. At act 402, the first mathematical model 202, which is a finite element analysis (FEA) model, of the piping stress analysis system 200 generates at least a first set of piping stresses, including membrane stresses and bending stresses, based on the piping data. The FEA model generates the membrane stresses and the bending stresses for all the cases for which the piping data has been obtained. The FEA model generates various stress plots and deformation plots to obtain the membrane stresses and the bending stresses. At act 403, the second mathematical model 203, which is a WRC 297 model, of the piping stress analysis system 200 generates at least a second set of piping stresses, including membrane stresses and bending stresses, based on the piping data, including the fifty cases that the FEA model analyzes.

At act 404, the stress optimization statistical model 204 of the piping stress analysis system 200 generates an optimized set of stresses based on the first set of piping stresses and the second set of piping stresses such that the optimized set of stresses may be used for designing a support structure for one or more pipes, in a reliable yet time and cost effective way. To generate an optimized set of stresses, at act 404A, a coefficient generation module 205 of the stress optimization statistical model 204 obtains mathematical coefficients based on the first set of piping stresses and the second set of piping stresses. To obtain mathematical coefficients, at act 404B, a relationship plotting module 205A of the coefficient generation module 205 plots two relationship plots of the first set of piping stresses and the second set of piping stresses. The first relationship plot is for the membrane stresses, and the second relationship plot is for the membrane stresses and the bending stresses in combination. Further, to obtain mathematical coefficients, at act 404C, a relationship identification module 205B of the coefficient generation module 205 identifies a data pattern in each of the relationship plots associated with the first set of piping stresses and the second set of piping stresses. This data pattern is a line, and based on a slope of the line, the coefficient generation module 205 generates mathematical coefficients for each of the relationship plots (e.g., relationship plot of membrane stresses and relationship plot of membrane stresses and bending stresses). At act 404D, the coefficient generation module 205 stores mathematical coefficients along with the first set of piping stresses and the second set of piping stresses in a coefficient database 207. Further, to generate an optimized set of stresses, at act 404E, the stress computation module 206 of the stress optimization statistical model 204 generates an updated set of piping stresses using the mathematical coefficients. These updated set of piping stresses are the optimized set of stresses (e.g., induced stresses in a support structure that will be supporting the pipes). These updated set of stresses will be used for designing the support structure.

FIG. 5 is a process flowchart illustrating one embodiment of a method 500 for determining piping stresses for a pipe by using the piping stress analysis system 200 illustrated in FIG. 2. At act 501, the data reception module 201 of the piping stress analysis system obtains design data associated with the pipe. The design data includes piping data associated with the pipe. In other words, instead of a plurality of pipe geometries, pipe materials, and pipe loading, the design data includes data associated with geometry, material, and loading of the pipe to be supported by a support structure and data associated with the support structure intended to be used. At act 502, the second mathematical model 203 (e.g., the WRC 297 model) of the piping stress analysis system 200 generates initial piping stresses having membrane stresses and bending stresses based on the design data.

At act 503, the coefficient generation module 205 of the piping stress analysis system 200 obtains the mathematical coefficients from the coefficient database 207 based on the initial piping stresses. For example, if the membrane stresses that the WRC 297 model generates are in a range of about 50 N/mm2 and 150 N/mm2, then the mathematical coefficients are 0.633 and 26. Similarly, if the sum of membrane stresses and bending stresses that the WRC 297 model generates are in a range of about 160 N/mm2 and 480 N/mm2, then the mathematical coefficients are 0.205 and 130. At act 504, the stress computation module 206 of the piping stress analysis system 200 generates updated piping stresses using the initial piping stresses and the mathematical coefficients, for example, by using the equation as shown below:

Supdated=C1(Spredicted)+C2

Supdated is an updated piping stress value, C1 and C2 are mathematical coefficients, and Spredicted is the stress value generated by the WRC 297 module. At act 504, the stress computation module 206 of the piping stress analysis system 200 validates the updated piping stresses based on a predefined stress range (e.g., compares the updated piping stresses with the predefined stress range). If the updated piping stresses are not valid with respect to the predefined stress range, then at act 505, the design data associated with the support structure is modified, for example, by varying physical dimensions of the support structure, and the acts 502 to 504 are re-iterated until the updated piping stresses are found to be valid. At act 506, if the updated piping stresses are valid, the piping stress analysis system 200 transmits the updated piping stresses to a system (not shown) that designs the support structure for the pipe (e.g., estimates physical dimensions of the support structure to be manufactured).

FIGS. 6A-6B illustrate relationship plots 600A and 600B between one or more sets of piping stresses generated by the piping stress analysis system 200 illustrated in FIG. 2. FIG. 6A illustrates the relationship plot 600A having data representing membrane stresses generated for each case of the piping data, by the first mathematical model 202 (e.g., the finite element analysis (FEA) model) and the second mathematical model 203 (e.g., the WRC 297 model). Similarly, FIG. 6B illustrates the relationship plot 600B having data representing sum of membrane stresses and bending stresses generated for each case of the piping data, by the first mathematical model 202 and the second mathematical model 203. The piping stress analysis system 200 identifies data points 601, 602, and 603, as shown in each of the FIGS. 6A and 6B, such that other data points on each of the relationship plots 600A and 600B are accommodated within a line drawn through these data points. The piping stress analysis system 200 further determines a slope of these lines for each of the relationship plots 600A and 600B, using the equation given below, and then obtains the mathematical coefficients.

y=mx+C

where ‘x’ and ‘y’ are the coordinates of the data points 601, 602, 603, etc., and ‘m’ and ‘C’ are the mathematical coefficients.

FIG. 7 illustrates a perspective view of an embodiment of a support structure 701 for which the stresses have been determined by employing the piping stress analysis system illustrated in FIG. 2 and the process flow chart illustrated in FIG. 5. The support structure 701 is a trunnion pipe supporting the pipe 702. The support structure 701 is manufactured cost effectively due to accurate estimation of induced stresses without running expensive finite element analysis models by employing the piping stress analysis system 200.

The various methods, algorithms, and computer programs disclosed herein may be implemented on computer readable media appropriately programmed for computing devices. As used herein, “computer readable media” refers to non-transitory computer readable media that participate in providing data (e.g., instructions that may be read by a computer, a processor, or a similar device). Non-transitory computer readable media include all computer readable media (e.g., non-volatile media, volatile media, and transmission media, except for a transitory, propagating signal).

The computer programs that implement the methods and algorithms disclosed herein may be stored and transmitted using a variety of media (e.g., the computer readable media) in a number of manners. In an embodiment, hard-wired circuitry or custom hardware may be used in place of, or in combination with, software instructions for implementation of the processes of various embodiments. Therefore, the embodiments are not limited to any specific combination of hardware and software. In general, the computer program codes including computer executable instructions may be implemented in any programming language. The computer program codes or software programs may be stored on or in one or more mediums as object code. Various aspects of the method and system disclosed herein may be implemented in a non-programmed environment including documents created, for example, in a hypertext markup language (HTML), an extensible markup language (XML), or other format that render aspects of a graphical user interface (GUI) 103H or perform other functions, when viewed in a visual area or a window of a browser program. Various aspects of the method and system disclosed herein may be implemented as programmed elements, or non-programmed elements, or any suitable combination thereof. The computer program product disclosed herein includes one or more computer program codes for implementing the processes of various embodiments.

Where databases are described such as the coefficient database 207 and the piping database 208, it will be understood by one of ordinary skill in the art that (i) alternative database structures to those described may be readily employed, and (ii) other memory structures besides databases may be readily employed. Any illustrations or descriptions of any sample databases disclosed herein are illustrative arrangements for stored representations of information. Any number of other arrangements may be employed besides those suggested by tables illustrated in the drawings or elsewhere. Similarly, any illustrated entries of the databases represent exemplary information only; one of ordinary skill in the art will understand that the number and content of the entries may be different from those disclosed herein. Further, despite any depiction of the databases as tables, other formats including relational databases, object-based models, and/or distributed databases may be used to store and manipulate the data types disclosed herein. Likewise, object methods or behaviors of a database may be used to implement various processes such as those disclosed herein. In addition, the databases may, in a known manner, be stored locally or remotely from a device that accesses data in such a database. In embodiments where there are multiple databases in the system, the databases may be integrated to communicate with each other for enabling simultaneous updates of data linked across the databases, when there are any updates to the data in one of the databases.

The present embodiments may be configured to work in a network environment including one or more computers that are in communication with one or more devices via a network. The computers may communicate with the devices directly or indirectly, via a wired medium or a wireless medium such as the Internet, a local area network (LAN), a wide area network (WAN) or the Ethernet, a token ring, or via any appropriate communications mediums or combination of communications mediums. Each of the devices includes processors, some examples of which are disclosed above, that are adapted to communicate with the computers. In an embodiment, each of the computers is equipped with a network communication device (e.g., a network interface card, a modem, or other network connection device suitable for connecting to a network). Each of the computers and the devices executes an operating system, some examples of which are disclosed above. While the operating system may differ depending on the type of computer, the operating system will continue to provide the appropriate communications protocols to establish communication links with the network. Any number and type of machines may be in communication with the computers.

The present invention is not limited to a particular computer system platform, processor, operating system, or network. One or more aspects of the present embodiments may be distributed among one or more computer systems (e.g., servers configured to provide one or more services to one or more client computers, or to perform a complete task in a distributed system). For example, one or more aspects of the present embodiments may be performed on a client-server system that includes components distributed among one or more server systems that perform multiple functions according to various embodiments. These components include, for example, executable, intermediate, or interpreted code that communicate over a network using a communication protocol. The present invention is not limited to be executable on any particular system or group of systems, and is not limited to any particular distributed architecture, network, or communication protocol.

The foregoing examples have been provided merely for the purpose of explanation and are in no way to be construed as limiting of the present invention disclosed herein. While the invention has been described with reference to various embodiments, it is understood that the words, which have been used herein, are words of description and illustration, rather than words of limitation. Further, although the invention has been described herein with reference to particular means, materials, and embodiments, the invention is not intended to be limited to the particulars disclosed herein; rather, the invention extends to all functionally equivalent structures, methods, and uses, such as are within the scope of the appended claims. Those skilled in the art, having the benefit of the teachings of this specification, may affect numerous modifications thereto, and changes may be made without departing from the scope and spirit of the invention in its aspects.

The elements and features recited in the appended claims may be combined in different ways to produce new claims that likewise fall within the scope of the present invention. Thus, whereas the dependent claims appended below depend from only a single independent or dependent claim, it is to be understood that these dependent claims may, alternatively, be made to depend in the alternative from any preceding or following claim, whether independent or dependent. Such new combinations are to be understood as forming a part of the present specification.

While the present invention has been described above by reference to various embodiments, it should be understood that many changes and modifications can be made to the described embodiments. It is therefore intended that the foregoing description be regarded as illustrative rather than limiting, and that it be understood that all equivalents and/or combinations of embodiments are intended to be included in this description.

1. A piping stress analysis system comprising:
a data reception module configured to obtain piping data associated with one or more pipes;
a first mathematical model configured to generate a first set of piping stresses based on the piping data;
a second mathematical model configured to generate a second set of piping stresses based on the piping data; and
a stress optimization statistical model comprising:
a coefficient generation module configured to obtain mathematical coefficients based on the first set of piping stresses and the second set of piping stresses; and
a stress computation module configured to generate an updated set of piping stresses using the mathematical coefficents, wherein the updated set of piping stresses are used for designing a support structure for the one or more pipes.

2. The piping stress analysis system of claim 1, wherein the piping data comprises physical data associated with the one or more pipes to be supported by the support structure, and
wherein the physical data comprises an outer diameter, a wall thickness, a length, and a material of each of the one or more pipes.

3. The piping stress analysis system of claim 1, wherein the piping data comprises physical data associated with the support structure, and
wherein the physical data comprises an outer diameter, a wall thickness, a length, and a material of the support structure.

4. The piping stress analysis system of claim 3, wherein the support structure is configured as a trunnion pipe.

5. The piping stress analysis system of claim 1, wherein the piping data comprises external factors affecting the support structure and the one or more pipes, and
wherein the external factors comprise a mechanical load exerted on the support structure, a mechanical load exerted on the one or more pipes, an internal pressure of the one or more pipes, and an internal temperature of the one or more pipes.

6. The piping stress analysis system f claim 1, wherein each of the first set of piping stresses and the second set of piping stresses one or more of membrane stresses and bending stresses experienced by the support structure.

7. The piping stress analysis system of claim 1, wherein the coefficient generation module comprises:
a relationship plotting module configured to generate at least one relationship plot of the first set of piping stresses and the second set of piping stresses; and
a relationship identification module configured to identify a data pattern in the at least one relationship plot, associated with the first set of piping stresses and the second set of piping stresses.

8. The piping stress analysis system of claim 1, further comprising a coefficient database configured to store the mathematical coefficients along with the first set of piping stresses and the second set of piping stresses.

9. A method for determining piping stresses for a pipe by using a piping stress analysis system, the method comprising:
obtaining design data associated with the pipe by a data reception module of the piping stress analysis system;
generating, by a mathematical model of the piping stress analysis system, initial piping stresses based on the design data;
obtaining the mathematical coefficients from a coefficient database by a coefficient generation module of the piping stress analysis system based on the initial piping stresses; and
generating, by a stress computation module of the piping stress analysis system, updated piping stresses using the initial piping stresses and the mathematical coefficients, wherein the updated set of piping stresses are used for designing a support structure for the pipe.

10. The method of claim 9, further comprising validating the updated piping stresses based on a predefined stress range by the stress computation module of the piping stress analysis system.

11. A method for analyzing piping stresses for one or more pipes, the method comprising:
obtaining piping data associated with the one or more pipes;
generating, by a first mathematical model, at least a first set of piping stresses based on the piping data;
generating, by a second mathematical model, at least a second set of piping stresses based on the piping data;
obtaining mathematical coefficients based on the first set of piping stresses and the second set of piping stresses; and
generating an updated set of piping stresses using the mathematical coefficients, wherein the updated set of piping stresses are used for designing a support structure for one or more pipes.

12. The method of claim 11, wherein obtaining the mathematical coefficients comprises:
generating at least one relationship plot of the first set of piping stresses and the second set of piping stresses; and
identifying a data pattern in the at least one relationship plot, associated with the first set of piping stresses and the second set of piping stresses.
